(19) United States
(12) Patent Application Publication
(10) Pub. No.: US 2005/0183745 A1
(43) Pub. Date: Aug. 25, 2005

(54) Tank cleaning device

(76) Inventor: David Glicksman, Dartmouth, MA (US)

Correspondence Address: David Glicksman, 53 Evelyn Street, Dartmouth, MA, 02747, US

(21) Appl. No.: 10/784,615

(22) Filed: Feb. 23, 2004

(51) Int. Cl. B08B 3/00

(52) U.S. Cl. 134/22.18; 134/24; 134/167 R

(57) ABSTRACT

A device for cleaning the inside of tanks or other storage containers used in the transporting or storage of liquids comprises a hollow, continuous, rigid pipe having a straight portion and a curved portion, the straight portion having a connecting end for connecting to a source of cleaning fluid, the curved portion being substantially semicircular and having a nozzle end for emitting a stream of cleaning fluid. The jet of cleaning fluid is directed against the inside walls and bottom of the tank facilitating removal of residual product and sediment.

### BACKGROUND OF THE INVENTION

1. Field of the Invention

This invention relates to a cleaning device. More particularly, this invention relates to a device for use in cleaning of tanks and other storage containers.

2. Description of the Prior Art

Tank and other storage containers used for storing and transporting liquids usually can only be cleaned with extreme difficulty. As used herein, the term tanks shall include other storage containers. All the residue and sediment must be removed before the tank can be placed back into service. It has been customary to clean the interior of such tanks by alternately steaming and/or washing down the interior. In some cleaning operations, workmen must enter the tank to operate high pressure cleaning hoses. This type of cleaning operation is extremely hazardous to the workmen. It presents the possibly that workmen might be exposed to noxious, explosive or otherwise hazardous fumes generated by the residue and sediment in a tank to be cleaned.

Prior art devices designed to clean the interior of tanks without necessitating the entrance of workmen into the tank tend

### BACKGROUND OF THE INVENTION

1. Field of the Invention

This invention relates to a cleaning device. More particularly, this invention relates to a device for use in cleaning of tanks and other storage containers.

2. Description of the Prior Art

Tank and other storage containers used for storing and transporting liquids usually can only be cleaned with extreme difficulty. As used herein, the term tanks shall include other storage containers. All the residue and sediment must be removed before the tank can be placed back into service. It has been customary to clean the interior of such tanks by alternately steaming and/or washing down the interior. In some cleaning operations, workmen must enter the tank to operate high pressure cleaning hoses. This type of cleaning operation is extremely hazardous to the workmen. It presents the possibly that workmen might be exposed to noxious, explosive or otherwise hazardous fumes generated by the residue and sediment in a tank to be cleaned.

Prior art devices designed to clean the interior of tanks without necessitating the entrance of workmen into the tank tend to be complex devices utlizing several nozzles or orifices for cleaning. This makes them costly to manufacture and difficult to manipulate. For example, U.S. Pat. No. 1,838,643 to Peterson et al, describes a complex tank cleaning device which utilizes a hose connected to a rigid vertical pipe for the distribution of the cleaning fluid. The nozzle of the hose is fixed to a gear box at the end of the vertical pipe. The inclination of the nozzle may be changed by rotating a set of beveled gears. The entire apparatus must be rotated in discrete steps and supported by a framework which rests on the tank.

It would be an advantage to provide a device which does not require a supporting frame or complex construction and can be used effectively to clean all the interior surfaces of the tank without necessitating workmaen breaking the plane of entry into the tank.

### SUMMARY OF THE INVENTION

It is an object of the invention to obviate the disadvantages of the prior art.

It is another object of the invention to provide a more mobile tank-cleaning device which does not require a support frame or complex construction.

It is a further object of the invention to provide a tank cleaning device which can direct a jet of cleaning fluid at all the interior surfaces of a tank to provide complete cleaning.

In accordance with one aspect of the invention, there is provided a device for cleaning tanks comprising a hollow, continuous, rigid pipe having a straight portion and a curved portion, the straight portion having a connecting end for connecting to a source of cleaning fluid, the curved portion being substantially semicircular and having a nozzle end for emitting a stream of cleaning fluid.

In accordance with another aspect of the invention, there is provided a method for cleaning tanks wherein the method involves inserting a tank cleaning device into a tank, the tank cleaning device comprising a hollow, continuous, rigid pipe having a center axis, straight portion and a curved portion, the straight portion having a connecting end for connecting to a source of cleaning fluid, the curved portion being substantially semicircular and having a center point and a nozzle end; supplying a source of pressurized cleaning fluid to the tank cleaning device to cause a jet of cleaning fluid to be emitted from the nozzle end; and rotating the tank cleaning device about the center axis and the center point to cause the jet of cleaning fluid to impinge on an interior wall of the tank.

In accordance with still another aspect of the invention, there is provided a device for cleaning tanks comprising a flexable hose having a nozle and connectable to a source of cleaning fluid, the flexible hose being disposed within a hollow, continuous, rigid pipe having a center axis, straight portion and a curved portion, the curved portion being substantially semicurcular and having a center point, and an open end, the nozzle being disposed in the open end of the curved portion.

In accordance with a further aspect of the invention, there is provided a method for cleaning tanks wherein the method involves inserting a tank cleaning device into a tank, the tank cleaning device comprising a flexible hose having a nozzle and connectable to a source of cleaning fluid, the flexible hose being disposed in a hollow, continous, rigid pipe having a center axis, straight portion and a curved portion, the curved potion being substantially semicurcular and having a center point, and an open end, the nozzle being disposed in the open end of the curved portion; suppling a source of cleaning fluid to the hose to cause a jet of cleaning fluid to be emitted from the nozzle; and rotating the tank cleaning device about the center axis and the center point to cause the jet of cleaning fluid to impinge on an interior wall of the tank.

Other features and advantages of the invention will be apparent from the following description taken in connection with the accompanying drawings.

### BRIEF DESCRIPTION OF THE DRAWINGS

FIG. 1 is a view of the tank cleaning device of the present invention.

FIGS. 2-6 are vertical cutaway views of a tank illustrating the use of the tank-cleaning device therein.

FIGS. 7 & 8 are views of alternate nozzle end designs of the tank-cleaning device.

FIG. 9 is a view of another embodiment of the tank-cleaning device wherein a flexible hose is inserted in a preformed distributor.

### DESCRIPTION OF THE PREFERRED EMBODIMENT

The present invention is a tank cleaning device which uses a continuous, curved, rigid distributor to emit a jet of cleaning fluid (i.e. water) from a nozzle connected to the end of the distributor. In another embodiment, a double braided hydraulic hose having a nozzle connected to its end is inserted into a preformed continuous, curved, rigid distributor to emit a cleaning fluid. The cleaning fluid may be steam or other suitable chemical cleaning fluid which is supplied to the distributor under pressure. The device has the ability to rotate freely around a center axis while permitting rapid and continuous adjustment of the inclination of the nozzle end with respect to the horizontal plane of the tank. This allows a jet of cleaning fluid to be rapidly directed to reach all the inside walls of a tank for complete cleaning. The cleaning fluid containing the residual product and sediment is washed down to the bottom of the tank where it is drawn off. The use of the present invention yields a complete cleaning sufficient to permit the tank to be placed back into service. Tanks amy be cleaned without necessitating the entrance of workmen into the tank or if desired the tank cleaning device permits a safer tank atmosphere to be obtained prior to workmen entering. Unlike other prior art devices, no supporting frame or complex mechanical devices are required to manipulate the nozzle.

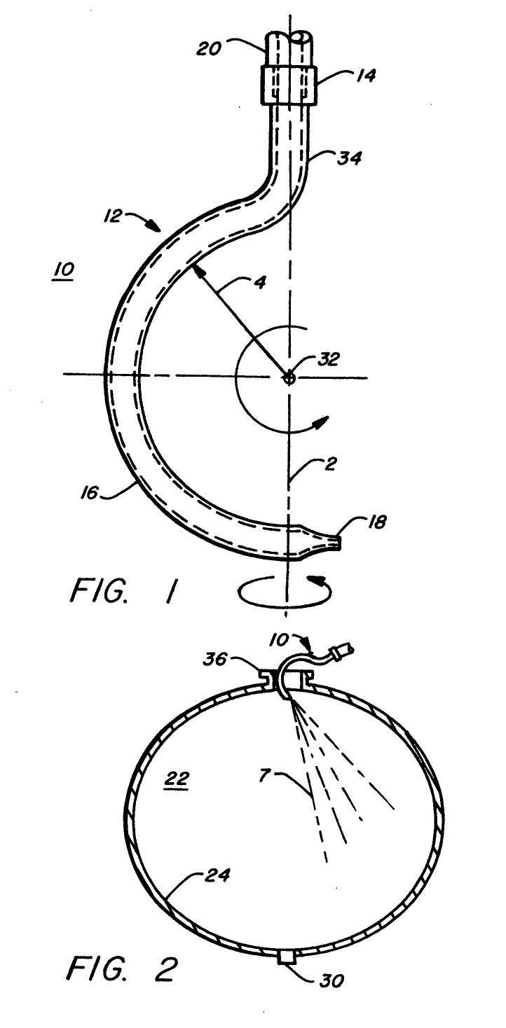

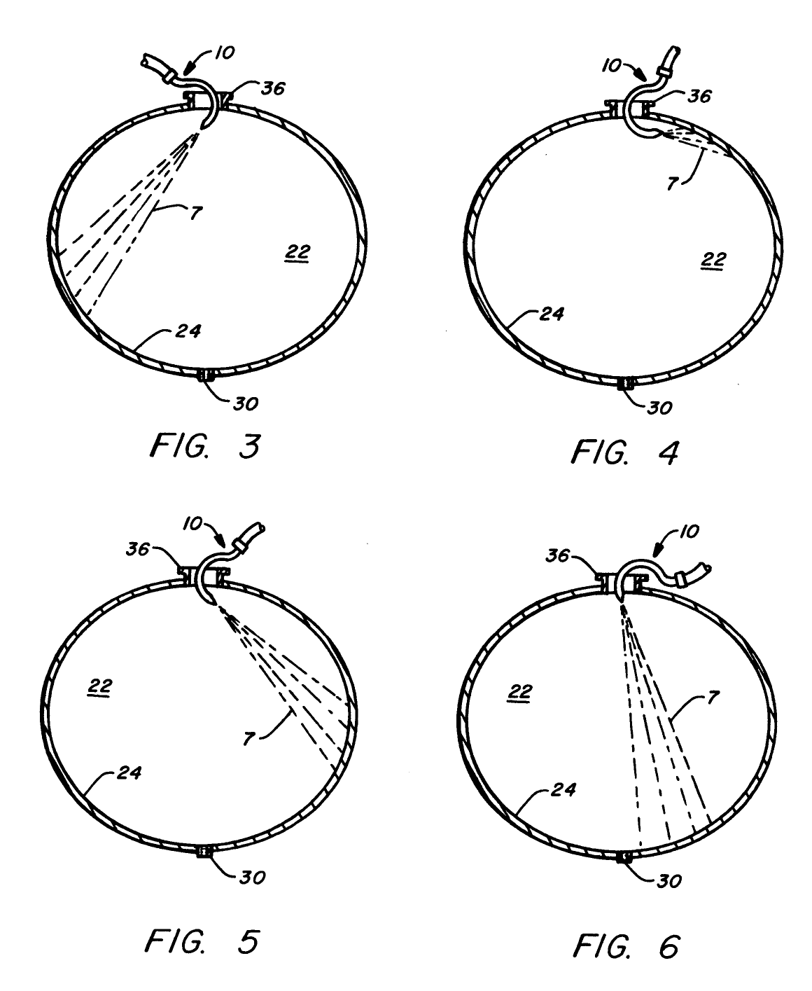

Referring to FIG. 1, one embodiment of a tank cleaning device 10 is formed of a hollow, continuous, pipe 12 capable of containing a pressurized fluid. The pipe 12 is made of a rigid material such as a plastic, metal or fiberglass although other suitable materials that are presently used in the manufacture of pipes and which are sufficiently rigid may also be used. Pipe 12 has a straight portion 34 and a curved portion 16. Straight portion 34 has a connecting end 14 for connecting to fluid supply coupling 20 which in turn is connected to a source or multiple sources of a pressurized cleaning fluid (not shown). Nozzle end 18 is attached to the curved portion 16 and opposite connecting end 14 for delivering a stream of fluid cleaning fluid to the tank walls. Nozzle end 18 may consist of a connector and a detachable nozzle. Curved portion 16 is substantially semicircular to allow the tank cleaning device 10 to be at least partially inserted into the tank through the manhole opening and to permit rapid and continuous adjustment of the inclination of nozzle 18 by rotating curved portion 16 about center point 32. Tank cleaning is effectuated by rotating the device 10 about center axis 2 while changing the inclination of nozzle 18. In this manner, a forceful stream of cleaning fluid capable of reaching the upper and lower interior surfaces of the tank is delivered in a revolving fashion. A few of different cleaning movements that may be made by tank cleaning device 10 are illustrated in FIGS. 2-6.

In a preferred embodiment, the continuous hollow pipe 12 is made of a plastic material. Plastic is preferred because of its ability to be readily shaped into a sufficiently rigid form while still light and strong. Curved portion 16 has a radius 4 of about 15 inches. The radius 4 may vary depending on the size of the tank to be cleaned or the tank opening. For example, a greater radius may be needed for the cleaning of a larger tank and conversely a smaller radius for a smaller vessel. The pipe 12 has an inside diameter of about 2 inches but may, depending on the size of the tank to be cleaned, be greater or lesser in diameter as necessary to facilitate the cleaning of different size tanks. The straight portion 34 of the pipe 12 has a connecting end 14 constructed so as to be connectable to a standard hose or pressure hose coupling. The pressure from the presurized source may vary from 20 psi to a high pressure of 4000 psi. For example, 20 psi normally is used to clean smaller tanks or drums. Variances may be made in the pressure depending on the container to be cleaned and the type of device needed for the pressure required. The straight portion 34 is normally about 6 inches in length, but may vary in length depending on the size of the tank and the depth that the device has to be inserted therein. The nozzle end 18 is tapered to a diameter narrower than pipe 12 so as to produce a high velocity jet of fluid exiting therefrom. Nozzle end 18 may also be constructed to accept a detachable nozzle to vary the force pattern and quantity of the fluid exiting therefrom. Fluid supply coupling 20 and connecting end 14 may be constructed to permit 360° rotation about center axis 2 without entangling the attached hose.

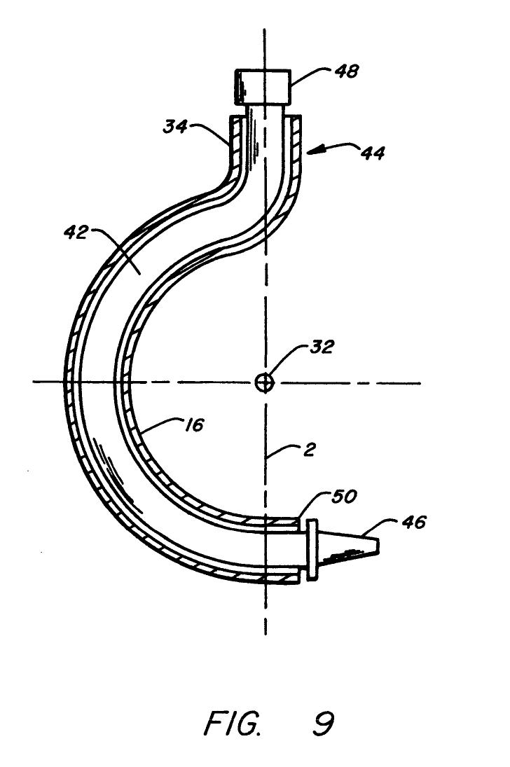

Another embodiment of the present invention, is shown in FIG. 9. A flexible hose 42 inserted within a preformed distributor 44 having the same shape as the hollow continuous pipe shown in FIG. 1.

Preferably, the flexible hose 42 is a double braided hydraulic hose. Preformed distributor 44, has a straight portion 34 and a curved portion 16. Straight portion 34 is used for directing the device when it has been placed within a tank. The hose 42 has a connecting end 48 for connecting to a fluid supply or to a source or multiple sources of a pressurized cleaning fluid (not shown). Nozzle 46 is attached to the end of the hose 42 and opposite the connecting end 48 for delivering a stram of fluid cleaning fluid to the tank walls. Nozzle 46 is disposed in the open end 50 of the curved portion 16. Curved portion 16 is substantially semicurcular to allow the tank cleaning device 10 to be at least partially inserted into the tank through the manhole opening clean out or clean out pipe.

Preferably distributor 44 is made of an aluminum material.

Although a pressure of 3000 psi is the pressure most commonly used with the device for the cleaning of tanks, for more problematic cleaning the invention could receive and deliver cleaning fluid at 4000 psi or higher psi at varied quantiaites in various patterns by utilizing matereials of different rigidity capable of withstanding higger pressure and heat requirements.

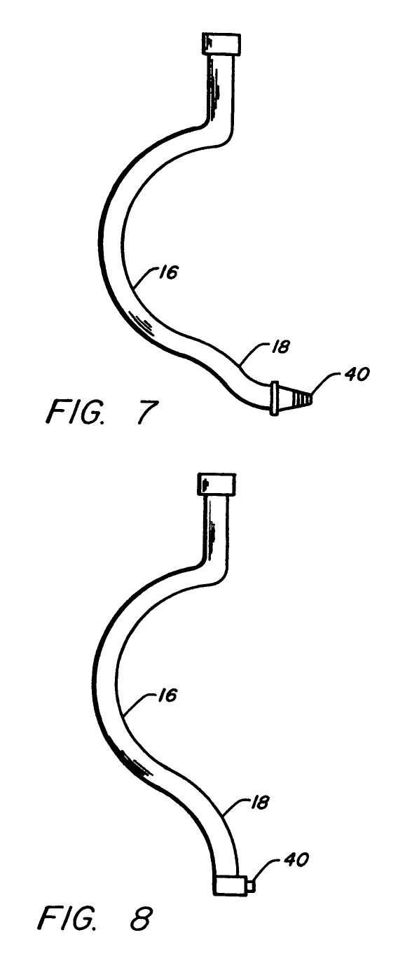

Alternative nozzle designs are shown in FIGS. 7 & 8. In these embodiments, the nozzle end 18 is slightly curved in the direction opposite the curvature of the curved portion 16. A detachable nozzle 40 is attached to the nozzle end 18.

Referring to FIGS. 2-6, tank cleaning device 10 is shown inserted through the opening, or manhole, 36 in the top of tank 22 to permit access to the interior of the tank. Near the bottom of interior wall 24 is an opening 30 for receiving a valve (not shown) whereby the contents of the tank 22 maybe emptied. Device 10 delivers the pressurized cleaning fluid outwardly in a jet stream 7 to impinge against the inner wall surfaces 24 of the tank 22 in a pattern defined by the rotating of the curved portion 16 about its center point 32 and about its center axis 2. Because the device has the ability to move simultaneously in two different directions, it is possible to generate a sweeping action, e.g. moving the jet stream 7 from side to side or from top to bottom, to more quickly clean the interior surface of the tank thereby making the cleaning process more efficient and thorough. The force of the jet stream and action of the cleaning fluid dislodge the residual product and sediment from the wall 24. The contaminated cleaning fluid is discharged through opening 30 and collected for proper disposal.

While the invention has been described with regard to a specific embodiment thereof, it will be understood by those skilled in the art to which the invention pertains that numerous changes may be made in the invention without departing from the spirit or scope thereof.

1. A device for cleaning tanks, comprising:
a hollow, continuous, rigid pipe having a straight portion and a curved portion, the straight portion having a connecting end for connecting to a source of cleaning fluid, the curved portion being substantially semicircular and having a nozzle end for emitting a stream of cleaning fluid.

2. The device of claim 1 wherein the curved portion is tapered to form the nozzle end.

3. The device of claim 1 wherein the nozzle end further comprises a connector and a detachable nozzle.

4. The device of claim 1 wherein said pipe is made from plastic.

5. The device of claim 1 wherein said pipe has an inside diameter of ¾ inches and the curved porion has a radius of about 15 inches.

6. The device of claim 1 wherein the connecting end comprises a coupling which is rotabable through 360°.

7. The device of claim 2 wherein the nozzle end of the pipe is sufficiently reduced in diameter so as to increase the velocity of the fluid exiting therefrom.

8. The device of claim 1 wherein the pipe is made from steel, aluminum or fiberglass.

9. A method for cleaning tanks, comprising:
(a) inserting a tank cleaning device into a tank, the tank cleaning device comprising a hollow, continuous, rigid pipe having a center axis, straight portion and a curved portion, the straight portion having a connecting end for connecting to a source of cleaning fluid, the curved portion being substantially semicircular and having a center point and a nozzle end;
(b) supplying a source of pressurized cleaning fluid to the tank cleaning device to cause a jet of cleaning fluid to be emitted from the nozzle end; and
(c) rotating the tank cleaning device about the center axis and the center point to cause the jet of cleaning fluid to impinge on an interior wall of the tank.

10. The method of claim 9 wherein the jet of cleaning fluid impinges on the interior wall in a sweeping motion.

11. The method of claim 9 wherein the jet of cleaning fluid is directed sequentially from an upper interior surface of the tank to a lower interior surface.

12. The method of claim 9 wherein contaminated cleaning fluid is removed from the tank through a discharge port in the bottom of the tank.

13. A device for cleaning tanks, comprising: a flexible hose having a nozzle and connectable to a source of cleaning fluid; the hose being disposed within a hollow, continuous, rigid pipe having a straight portion, and a curved portion; the curved portion being substantially semicurcular and an open end; the nozzle being disposed in the open end of the curved portion.

14. The device of claim 13 wherein the flexible hose is a high pressure, heat resistant, braided rubber hose.

15. The device of claim 13 wherein said pipe is made from aluminum, steel fiberglass or plastic.

16. A method for cleaning tanks, comprising;
(a) inserting a tank cleaning device into a tank, a fleible hose having a nozzle and connectable to a source of cleaning fluid, the fleible hose being disposed within a hollow, coninuous, rigid pipe having a center axis, a straight portion and a curved portion, the curved portion being substantially semicurcular and having a center point and an open end; the nozzle being disposed in the open end of the curved portion.
(b) Applying a source of pressurized cleaning fluid to the hose to cause a jet of cleaning fluid to be emitted from the nozzle; and
(c)rotating the tank cleaning device about the center axis and the center point to cause the jet of cleaning fluid to impinge on an interior wall of the tank.

17. The method of claim 16 wherein the jet of cleaning fluid impinges on the interior wall in sweeping motion.

18. The method of claim 16 wherein the jet of cleaing fluid id directed sequentially from an upper interior surface of the tank to a lower interior surface.

19. The method of claimn 16 wherein contaminated cleaning fluid is removed from the tank through a discharge port in the bottom of the tank.
